(19) United States
(12) Patent Application Publication
(10) Pub. No.: US 2006/0247382 A1
(43) Pub. Date: Nov. 2, 2006

(54) Monolayer film for label feedstock

(76) Inventor: W. Douglas Lilac, Williamsburg, VA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/120,059

(22) Filed: May 2, 2005

(51) Int. Cl. C08L 23/04

(52) U.S. Cl. 525/240; 524/502

(57) ABSTRACT

The present invention provides a monolayer film for use as label feedstock. The present film includes a blend of polyolefin polymer and an ethylene copolymer. In a preferred embodiment, the present film also includes an antiblocking agent.

### CROSS-REFERENCE TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

The present invention relates generally to synthetic films and, more particularly, to a monolayer film for use as label feedstock.

Label feedstock often includes paper or other suitable material having a face material of polymeric film or other material that imparts to the label qualities not provided by the paper itself. These qualities include strength, weatherability, water resistance, gloss, abrasion resistance, and others. Often, it may be desirable to eliminate the paper or other material entirely and simply use the film itself as label feedstock. The use of polymeric film as label feedstock is also known in the art. Such films, however, are generally multilayer in construction, often having a surface layer for printing thereon, a core layer for structure and stiffness, and a bottom layer for increased bonding of an adhesive that will be applied to the label so that the label can be affixed to a surface.

Such multilayer films consume more time and resources during manufacture than would a monolayer film. Further, the multilayer films have thickness constraints not found in monolayer films. What is needed, therefore, is a monolayer film suitable for use as label feedstock.

### BRIEF SUMMARY OF THE INVENTION

The present invention provides a monolayer film for use as label feedstock. The present film includes a blend of polyolefin polymer and an ethylene copolymer. In a preferred embodiment, the present film also includes an antiblocking agent.

It is preferred that the polyolefin polymer of the present invention is a propylene polymer, most preferably a random copolymer polypropylene. Polypropylene homopolymer may also be used. The ethylene polymer is preferably ethylene vinyl acetate, though other suitable ethylene copolymers may also be used. Other suitable ethylene copolymers include ethylene acrylates, ethylene acrylic acid terpolymers, ethylene vinyl acetate terpolymers, and combinations thereof.

The polyolefin polymer of the present invention is preferably present in a range of from about 30 percent to about 90 percent by weight of the film, and more preferably in the range of from about 30 percent to about 70 percent by weight of said film. Most preferably, the polyolefin polymer is present in an amount of about 50 percent by weight of the film.

The ethylene copolymer of the present invention is preferably present in a range of from about 10 percent to about 70 percent by weight of the film, and more preferably in the range of from about 30 percent to about 50 percent by weight of the film. Most preferably, the ethylene copolymer is present in an amount of about 49 percent by weight of the film.

The antiblocking agent of the present film is preferably present in an amount of about 1 percent by weight of said film.

### BRIEF DESCRIPTION OF THE DRAWINGS

Not Applicable.

### DETAILED DESCRIPTION OF THE INVENTION

The monolayer film of the present invention preferably includes a polyolefin/ethylene copolymer blend. The polyolefin component of the blend provides strength, structural integrity, and the like, whereas the ethylene copolymer provides functionality as label feedstock—a surface that is capable of being printed upon. In a preferred embodiment, the present invention further includes an antiblocking agent. The total thickness of the film may vary according to the specific application of the film. The preferred film has a thickness of from about 0.8 mil to about 10.0 mil, and more preferably from about 1.0 mil to about 2.5 mil. Most preferably, the film of the present invention has a thickness of about 2.5 mil.

The present monolayer blend provides versatility in factory production while maintaining performance standards that are at least as high as those of the typical multilayer film used for the same purpose. In a preferred embodiment of the present film, the polyolefin polymer is a polypropylene polymer such as a polypropylene homopolymer, a random copolymer polypropylene, or a combination thereof. More preferably, the polyolefin polymer is a random copolymer polypropylene. The random copolymer polypropylene may have, for example, up to about 5% polyethylene. Alternatively, in some embodiments of the present invention, polyethylene or other polyolefins may be substituted for polypropylene.

The ethylene copolymer of the present film is preferably ethylene vinyl acetate (EVA), though other ethylene copolymers may also be used. Other suitable ethylene copolymers include ethylene acrylates, ethylene acrylic acid terpolymer, ethylene vinyl acetate terpolymer, and combinations thereof.

A preferred embodiment of the present film comprises about 50% random copolymer polypropylene, about 49% ethylene vinyl acetate, and about 1% of an antiblocking agent. The film preferably has a thickness of from about 0.8 mil to about 10.0 mil, and more preferably of about 2.5 mil. Generally, the film has an initial thickness of about 10.0 mil, and is then machine-direction oriented to a thickness of from about 0.8 mil to about 10.0 mil. Though the percentages of random copolymer polypropylene and EVA given above are preferred, it is contemplated that the percentages of both polypropylene and EVA may be varied by up to about +/−20%.

The film of the present invention may be produced by conventional methods used in producing films, including blown or cast film techniques. In producing a cast film, molten polymer is poured or extruded onto a cold surface such as a chill roll. In blown film extrusion, the molten polymer is extruded through a die slit, usually vertically, to form a thin-walled tube of polymer. Air is forced through a hole in the center of the die to blow up the tube of polymer like a balloon. The tube moves upward, cooling until it passes through nip rolls, where it is flattened to create a “lay-flat” tube of film. The lay-flat film is either kept as it is, or the edges are cut off to produce two flat film sheets that are then wound onto reels. In cast film extrusion, polymer molecules are oriented in the machine-direction only, resulting in a great deal of difference between machine-direction and transverse-direction properties of the film. In blown film extrusion, the molecular orientation of the polymer is achieved in both machine and transverse direction. This results in a film with biaxial properties.

### EXAMPLE 1

### Method of Producing Films of the Present Invention

A preferred method for producing the films of the present invention is now described. As a first step, components are blended at a loss-in-weight blender and combined in the desired proportions (described more fully with respect to specific films, below), then sent to the feed portion of an extruder. This process allows for dry-blending of ingredients, thereby avoiding the need to utilize more expensive, fully compounded blends. A dedicated extruder mixes, melts, and meters the components to a monolayer film. A flat, single slot die extrudes the film onto a smooth chill cast roll, producing the flat film product.

Although the preferred film includes about 50% polypropylene, it is contemplated that any suitable polyolefin polymer may be substituted for polypropylene. Preferred polyolefins include polyethylene, polypropylene, polybutenes, polyisoprenes, copolymers thereof, terpolymers thereof, α-olefin propylene copolymers, and mixtures thereof. Any other suitable polyolefin polymers may also be used.

It will be appreciated by those skilled in the art that additives may be added to the film of the present invention in order to improve certain characteristics of the film. Preferred additives include color concentrates, neutralizers, process aids, lubricants, stabilizers, hydrocarbon resins, antistatics, and antiblocking agents. A color concentrate may be added to yield a colored layer, an opaque layer, or a translucent layer. Preferred color concentrates include color formulations, including black, white, and other colors suitable for the film of the present invention.

Suitable neutralizers include calcium carbonate and calcium stearate. Preferred neutralizers have an absolute particle size of less than 10 μm and a specific surface area of at least 40 m²/g. Polymeric processing aids may also be used in the present film. Fluoropolymers, fluoropolymer blends, and fluoroelastomers are particularly preferred, but any processing aid known in the art for use in polymer films is suitable.

Lubricants that may be used in accordance with the present invention include higher aliphatic acid esters, higher aliphatic acid amides, metal soaps, polydimethylsiloxanes, and waxes. Conventional stabilizing compounds for polymers of ethylene, propylene, and other α-olefins are preferably employed in the present invention. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity, and optical properties. In particular, adhesive resins are preferred. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments.

Preferred antistatics include substantially straight-chain and saturated aliphatic, tertiary amines containing an aliphatic radical having 10-20 carbon atoms that are substituted by ω-hydroxy-(C₁-C₄)-alkyl groups, and N,N-bis-(2-hydroxyethyl)alkylamines having 10-20 carbon atoms in the alkyl group. Other suitable antistatics include ethoxylated or propoxylated polydiorganosiloxanes such as polydialkysiloxanes and polyalkylphenylsiloxanes, and alkali metal alkanesulfonates.

Preferred antiblocking agents include organic polymers such as polyamides, polycarbonates, and polyesters. Other preferred agents include calcium carbonate, aluminum silicate, magnesium silicate, calcium phosphate, silicon dioxide, and diatomaceous earth. Particularly preferred for use as an antiblocking agent is Ampacet® RM100458.

The present invention is further illustrated by the following examples, which are not to be construed in any way as imposing limitations upon the scope thereof. On the contrary, it is to be clearly understood that various other embodiments, modifications, and equivalents which, after reading the description herein, may suggest themselves to those skilled in the art, may be used without departing from the spirit of the present invention and/or the scope of the appended claims.

### EXAMPLES OF FILM STRUCTURES IN ACCORDANCE WITH THE PRESENT INVENTION

A monolayer film having a total thickness of about 10 mil, prior to machine-direction orientation, and about 2.5 mil after machine-direction orientation, was produced including the components set forth in Table 1.

TABLE 1
Formulation A

| Percent (w) of | | |
|---|---|---|
| Film | Polymer | Additive |
| 50% | Random Copolymer | 0 |
| | Polypropylene | |
| 49% | Ethylene Vinyl Acetate | 0 |
| 1% | Antiblocking Agent | 0 |

An example of specific products that may be used in the manufacture of the Table 1 film are provided in Table 2, below.

TABLE 2
Formulation B

| Percent (w) of | | |
|---|---|---|
| Film | Polymer | Additive |
| 50% | Equistar PP35NF01 | 0 |
| 49% | Equistar UESP307 | 0 |
| 1% | Ampacet RM100458 | 0 |

The films described in tables 1 and 2 were produced by a cast film method. The polypropylene polymer used had a resin density of about 0.900 and a melt index of about 2.0. The ethylene vinyl acetate had a resin density of about 0.900 and a melt index of about 3.0. The antiblocking agent had a resin density of about 0.920 and a melt index of about 2.3.

A monolayer film having a total thickness of about 7 mil, prior to machine-direction orientation, and about 1.75 mil after machine-direction orientation, was produced including the components set forth in Table 3.

TABLE 3
Formulation C

| Percent (w) of | | |
|---|---|---|
| Film | Polymer | Additive |
| 50% | Random Copolymer | 0 |
| | Polypropylene | |
| 49% | Ethylene Vinyl Acetate | 0 |
| 1% | Antiblocking Agent | 0 |

An example of specific products that may be used in the manufacture of the Table 1 film are provided in Table 2, below.

TABLE 4
Formulation D

| Percent (w) of | | |
|---|---|---|
| Film | Polymer | Additive |
| 50% | Equistar PP35NF01 | 0 |
| 49% | Equistar UESP307 | 0 |
| 1% | Ampacet RM100458 | 0 |

The films described in tables 3 and 4 were produced by a cast film method. The polypropylene polymer used had a resin density of about 0.900 and a melt index of about 2.0. The ethylene vinyl acetate had a resin density of about 0.900 and a melt index of about 3.0. The antiblocking agent had a resin density of about 0.920 and a melt index of about 2.3.

A monolayer film having a total thickness of about 9 mil prior to machine-direction orientation, and from about 1.75 to about 2.5 mil after machine-direction orientation, was produced including the components set forth in Table 5.

TABLE 5
Formulation E

| Percent (w) of | | |
|---|---|---|
| Film | Polymer | Additive |
| 50% | Random Copolymer | 0 |
| | Polypropylene | |
| 49% | Ethylene Vinyl Acetate | 0 |
| 1% | Antiblocking Agent | 0 |

An example of specific products that may be used in the manufacture of the Table 1 film are provided in Table 2, below.

TABLE 6
Formulation F

| Percent (w) of | | |
|---|---|---|
| Film | Polymer | Additive |
| 50% | ExxonMobil PP9524E2 | 0 |
| 49% | Equistar UESP307 | 0 |
| 1% | Ampacet RM100458 | 0 |

The films described in tables 5 and 6 were produced by a cast film method. The polypropylene polymer used had a resin density of about 0.900 and a melt index of about 12.0. The ethylene vinyl acetate had a resin density of about 0.900 and a melt index of about 3.0. The antiblocking agent had a resin density of about 0.920 and a melt index of about 2.3.

A monolayer film having a total thickness of about 9 mil prior to machine-direction orientation, and from about 1.75 to about 2.5 mil after machine-direction orientation, was produced including the components set forth in Table 7.

TABLE 7
Formulation G

| Percent (w) of | | |
|---|---|---|
| Film | Polymer | Additive |
| 70% | Random Copolymer | 0 |
| | Polypropylene | |
| 29% | Ethylene Vinyl Acetate | 0 |
| 1% | Antiblocking Agent | 0 |

An example of specific products that may be used in the manufacture of the Table 1 film are provided in Table 2, below.

TABLE 8
Formulation H

| Percent (w) of | | |
|---|---|---|
| Film | Polymer | Additive |
| 70% | ExxonMobil PP9524E2 | 0 |
| 29% | Equistar UESP307 | 0 |
| 1% | Ampacet RM100458 | 0 |

The films described in tables 7 and 8 were produced by a cast film method. The polypropylene polymer used had a resin density of about 0.900 and a melt index of about 12.0. The ethylene vinyl acetate had a resin density of about 0.900 and a melt index of about 3.0. The antiblocking agent had a resin density of about 0.920 and a melt index of about 2.3.

A monolayer film having a total thickness of about 9 mil prior to machine-direction orientation, and from about 1.75 to about 2.5 mil after machine-direction orientation, was produced including the components set forth in Table 3.

TABLE 9
Formulation I

| Percent (w) of | | |
|---|---|---|
| Film | Polymer | Additive |
| 89% | Random Copolymer | 0 |
| | Polypropylene | |
| 10% | Ethylene Vinyl Acetate | 0 |
| 1% | Antiblocking Agent | 0 |

An example of specific products that may be used in the manufacture of the Table 1 film are provided in Table 2, below.

TABLE 10
Formulation J

| Percent (w) of | | |
|---|---|---|
| Film | Polymer | Additive |
| 89% | ExxonMobil PP9524E2 | 0 |
| 10% | Equistar UESP307 | 0 |
| 1% | Ampacet RM100458 | 0 |

The films described in tables 9 and 10 were produced by a cast film method. The polypropylene polymer used had a resin density of about 0.900 and a melt index of about 12.0. The ethylene vinyl acetate had a resin density of about 0.900 and a melt index of about 3.0. The antiblocking agent had a resin density of about 0.920 and a melt index of about 2.3.

The foregoing description of the embodiments of the invention has been presented for purposes of illustration and description, and is not intended to be exhaustive or to limit the invention to the precise form disclosed. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

1. A monolayer film for use as label feedstock comprising a polyolefin polymer and an ethylene copolymer.

2. The monolayer film according to claim 1 further comprising an antiblocking agent.

3. The monolayer film according to claim 1 wherein said polyolefin polymer is selected from the group consisting of polypropylene homopolymer, random copolymer polypropylene, and combinations thereof.

4. The monolayer film according to claim 3 wherein said ethylene copolymer is selected from the group consisting of ethylene vinyl acetate, ethylene acrylates, ethylene acrylic acid terpolymers, ethylene vinyl acetate terpolymers, and combinations thereof.

5. The monolayer film according to claim 3 wherein said polyolefin polymer is a random copolymer polypropylene.

6. The monolayer film according to claim 3 wherein said ethylene copolymer is ethylene vinyl acetate.

7. The monolayer film according to claim 3 wherein said polyolefin polymer is a random copolymer polypropylene and said ethylene copolymer is ethylene vinyl acetate.

8. The monolayer film according to claim 1 wherein said polyolefin polymer is present in a range of from about 30 percent to about 90 percent by weight of said film.

9. The monolayer film according to claim 1 wherein said ethylene copolymer is present in a range of from about 10 percent to about 70 percent by weight of said film.

10. A monolayer film for use as label feedstock comprising:
a polypropylene polymer selected from the group consisting of polypropylene homopolymer, random copolymer polypropylene, and combiantions thereof,
ethylene vinyl acetate; and
an antiblocking agent.

11. The monolayer film according to claim 10 wherein said polypropylene polymer is present in an amount of from about 30 percent to about 70 percent by weight of said film.

12. The monolayer film according to claim 11 wherein said ethylene vinyl acetate is present in an amount of from about 29 percent to about 69 percent by weight of said film.

13. The monolayer film according to claim 10 wherein said ethylene vinyl acetate is present in an amount of from about 29 percent to about 69 percent by weight of said film.

14. The monolayer film according to claim 10 wherein said polypropylene polymer is a random copolymer polypropylene.

15. The monolayer film according to claim 14 wherein said random copolymer polypropylene is present in an amount of from about 29 percent to about 69 percent by weight of said film.

16. A monolayer film for use as label feedstock comprising:
random copolymer polypropylene in an amount of about 50 percent by weight of said film;
ethylene vinyl acetate in an amount of about 49 percent by weight of said film; and
an antiblocking agent in an amount of about 1 percent by weight of said film.
